(19) United States
(12) Patent Application Publication
(10) Pub. No.: US 2017/0319997 A1
(43) Pub. Date: Nov. 9, 2017

(54) FILTER ELEMENT

(71) Applicant: Mahle International GmbH, Stuttgart (DE)

(72) Inventor: Alexander Jerger, Sachsenheim (DE)

(21) Appl. No.: 15/533,007

(22) PCT Filed: Nov. 30, 2015
(86) PCT No.: PCT/EP2015/078093

§ 371 Date: Jun. 2, 2017

(30) Foreign Application Priority Data
Dec. 3, 2014 (DE) 102014224766.7

(51) Int. Cl. B01D 46/00; B01D 46/10; B01D 46/12

(52) U.S. Cl. CPC B01D 46/0005; B01D 46/12; B01D 46/0026; B01D 46/002; B01D 46/103; B01D 2265/028; B01D 2279/60

(57) ABSTRACT

A filtering system may include a holder and an exchangeable filter element. The filter element may include a first end plate, a second end plate, and a filtering material arranged between the first end plate and the second end plate that separates a filtered zone from an unfiltered zone. The second end plate may protrude beyond the filtering material. The filtering system may further include at least one filtered opening and at least one unfiltered opening, and the at least one filtered opening may be disposed in the filter element. The filter element may lie detachably on the holder, and the holder together with the second end plate, the filtering material and an outer wall may enclose the unfiltered zone.

### CROSS-REFERENCE TO RELATED APPLICATIONS

This application claims priority to German Patent Application No. 10 2014 224 766.7 filed on Dec. 3, 2014, and International Patent Application No. PCT/EP2015/078093, filed Nov. 30, 2015, the contents of which are hereby incorporated by reference in their entirety.

### TECHNICAL FIELD

The invention relates to a filtering system, in particular for an internal combustion engine or a combustion machine of a motor vehicle, having a holder on the vehicle and an exchangeable filter element, in particular an air filter element, wherein the filter element comprises a first end plate, a second end plate and a filtering material that is arranged between the end plates and separates a filtered air zone from an unfiltered air zone. The invention further relates to a method for producing a filter element for such a filtering system.

### BACKGROUND

Such filtering systems are used for example in the fresh air intake tract of internal combustion engines or in fuel cells. Usually, such filtering systems have a filter housing, into which a filter element is inserted and which encloses an unfiltered air zone and a filtered air zone. After reaching the service life of the filter element, the latter can be removed from the filter housing and exchanged for a new one. In such filtering systems it is important that the seal between the filter element and the filter housing functions properly. This can be a problem in particular after frequent changing of the filter element. Furthermore, the filter housing must be opened and later closed again properly. For this, frequently special tools are required, so that the exchange of the filter element is laborious. Such a filtering system is known for example from GB 2 162 087 A or WO 2012/084753 A1.

The present invention is based on the problem of providing a filtering system by which the maintenance effort can be reduced.

This problem is solved by the independent claim(s). Further advantageous embodiments are the subject of the dependent claims.

### SUMMARY

The invention is based on the general idea of constructing the filter element such that no filter housing is required, in particular of forming the filtered air zone exclusively by the filter element. In this way, on the one hand the filtered air zone can be sealed very reliably from the unfiltered air zone. On the other hand, the overall volume of the filter element can thereby be reduced, because no additional housing is required. Furthermore, the maintenance effort is simplified, because the filter element does not have to be laboriously removed from a housing and inserted again. This is achieved in that at least the second end plate protrudes beyond the filtering material, that the filtering material has at least one filtered air opening and at least one unfiltered air opening, wherein at least one such filtered air opening is formed in the filter element, that the filter element lies detachably on the holder, and that the holder, the protruding second end plate, the filtering material and an outer wall enclose the unfiltered air zone. Provision is further made that the unfiltered air zone is delimited inwardly by the filtering material and outwardly by the outer wall, that the outer wall runs adapted to a course of the filtering material, that the outer wall runs transversely to the end plates. Therefore, the filtering material of the filter element is enclosed and protected from damage. Furthermore, the filtering material is tightly connected with the end plates, so that a proper operation of the filter element is possible, so that the filtered air zone does not have to be sealed by a detachable seal. In this way, an extremely compact construction of the filter element, and thereby of the filtering system, is produced, so that the filtering system requires less installation space, for example within the engine compartment of a motor vehicle.

It is favourable that the filtering material and the end plates are connected with one another in a substance-bonded manner. For example, the filtering material and the end plates can be connected to one another by gluing or plasticizing. The substance-bonded connection of filtering material and the end plates provides a tight connection between the filtering material and the end plates, so that air which flows through the filter element must flow through the filtering material and is thus filtered. A flowing of unfiltered air past the filtering material can therefore be prevented.

In the description and the enclosed claims, “plasticizing” is designated as a connecting technique in which one of the objects which are to be connected is heated at the connection site until the material becomes plastic, then the other object is pressed onto this connection site so that said other object dips in partially and likewise partially becomes slightly plastic, so that a form-fitting and partially substance-bonded connection arises between the two objects.

In addition, it is favourable if a through-flow direction of the filtering material runs substantially parallel to the end plates. In this way, a particularly compact construction of the filter element can be achieved.

A particularly favourable possibility makes provision that the end plates lie against the filtering material at opposite sides of the filtering material. In this way, the filtered air zone and the unfiltered air zone can be separated particularly favourably by the filtering material.

According to another example the outer wall is held securely against the protruding end plate or is formed integrally with the end plate, wherein the outer wall lies loosely on the holder. Thereby, the unfiltered air zone can be sealed well.

It is particularly advantageous if a sealing element is arranged between the outer wall and the holder. Thereby, the unfiltered air zone can be sealed even better with respect to the environment.

A favourable variant makes provision that the holder is formed by a flat component or on a flat component. Thereby, the holder can cover the unfiltered air zone in a particularly favourable manner. Such flat components can be, for example, a bodywork part, a design cover, a housing cover, a cylinder head cover, an engine bonnet, an engine compartment rear wall or an oil sump.

A further advantageous solution according to another example makes provision that the outer wall is held securely on the holder or is formed integrally with the holder, wherein the outer wall lies loosely on the protruding end plate. This is favourable for maintenance, because the outer wall does not also have to be exchanged.

Furthermore, a particularly advantageous solution makes provision that a sealing element is arranged between the outer wall and the at least one protruding end plate. Thereby, the unfiltered air zone can be sealed even better with respect to the environment.

A favourable variant makes provision that the filter element is connected to the holder by a clip connection, a screwed connection, a clamping connection and/or a plug-in connection.

A further favourable possibility for a compact construction makes provision that the outer wall runs, at least in sections, transversely, in particular substantially perpendicularly, to at least one of the end plates.

In the description and in the enclosed claims, substantially perpendicular is understood to mean an angle between 70 and 110, preferably between 80 and 100, particularly preferably between 88 and 92°.

It is particularly favourable that the outer wall has an I profile. This means that the outer wall runs in a straight line between the protruding end plate to the holder. In this way, a compact and stable outer covering of the filtering system is formed.

In addition, a further particularly favourable possibility makes provision that the outer wall has a C profile. This means that the outer wall does not run in a straight line from the protruding end plate to the holder, but rather in a curve. In this way, a greater distance can be achieved between the outer wall and the filtering material.

An advantageous possibility makes provision that the end plates are substantially flat. In this way, no unnecessary space is taken up, so that the filter element is space-efficient. Furthermore, the end plates can therefore be punched or cut for example from larger sheets. Thereby, from one type of sheets, end plates can be produced for various filter elements, in particular of different size, so that the storage costs can be reduced.

A further advantageous possibility makes provision that the outer wall is formed from a functional strip. Different elements can be produced flexibly from one functional strip, so that the variety of primary materials can be reduced, which reduces storage costs.

In the description and the enclosed claims, a functional strip is understood to mean an endless strip, in particular of plastic or metal, which can be transported for example in a rolled-up state. The functional strip has a constant width and thickness and can be cut, for example, to the correct length, in order to form therefrom the outer wall of the filter element.

It is favourable that the filtered air zone is largely enclosed by the two end plates and the filtering material. Largely enclosed means that one or more openings are provided, through which filtered clean air can flow out from the filter element and the filtering system. These elements are securely connected to one another, in particular in a substance-bonded manner, so that the transitions between the elements are tight. Therefore, it can be prevented that raw air can arrive unfiltered into the filtered air zone.

A favourable variant makes provision that the unfiltered air zone is constructed in a channel-shaped manner, in particular with a rectangular cross-section and preferably with a curved course. Through the fact that the unfiltered air zone is constructed in a channel-shaped manner, the dimensions of the filter element can be adapted in a targeted manner, in particular to the installation space which is available. The rectangular configuration of the cross-section of the unfiltered air zone offers a variant which is simple and easy to produce. By the curved course of the unfiltered air zone, the filter element can be adapted even better to the installation space which is available, for example a horseshoe-shaped unfiltered air zone and therefore also a horseshoe-shaped filtering material can be formed, which enables a compact construction of the filter element.

A particularly favourable variant makes provision that further elements are arranged in the unfiltered air zone, for example guide vanes, throttle valves, supporting domes, dust discharge valves and/or rotating components. Thus, for example, the air flow can be optimized, the stability can be increased or the lifespan can be lengthened.

A particularly favourable variant makes provision that the outer wall has recesses which are covered by a non-woven material. Thereby, condensation can flow from the unfiltered air zone out from the filter element. The flow resistance through the recesses covered with non-woven material is greater here than the flow resistance through the unfiltered air opening. For this reason, recesses covered with non-woven material can also be arranged in a lower region of the filter element, so that the water can run out particularly favourably, without in so doing drawing in large amounts of warm air from the engine compartment in an unfavourable manner. Moreover, it is possible to draw in mixed air in a targeted manner, namely a mixture of external air, which is cool, and air from the engine compartment, which is heated.

An advantageous solution makes provision that the outer wall has, at least in sections, reinforcement ribs which run transversely to the end plates. Thereby, the stability of the outer wall is improved.

A further solution which is advantageous for the stability makes provision that the outer wall has, at least in sections, a corrugation. Furthermore, the corrugation offers the possibility of the mounting of elements, through a type of detent connection, as is also to be found for example in cable ties.

In a favourable manner, the outer wall has at least one interruption, in which functional elements are arranged. Such functional elements can be, for example, an unfiltered air connection of the at least one unfiltered air opening or a holding element, by which the filter element can be additionally fastened to the vehicle.

In an advantageous manner, the at least one unfiltered air opening is arranged in the outer wall, in particular in an interruption of the outer wall. Thereby, the unfiltered air opening can be positioned in a variable manner on the filter element, so that the filter element is able to be adapted in a particularly favourable manner.

It is particularly preferred that an unfiltered air connection is arranged at the at least one unfiltered air opening. Through the unfiltered air connection, for example, a pipe can be connected to the filter element, through which unfiltered air is fed from a different location. For example, air can be drawn in from a location situated higher, in order, in particular in off-road vehicles, to prevent a drawing in of water.

It is favourable if the unfiltered air connection is held detachably at the unfiltered air opening. For example, the unfiltered air connection can be screwed, plugged, clamped, fastened with brackets and/or with a clip connection on the filter element. Thereby, in the case of a changeover of the filter element, the unfiltered air connection can remain in the vehicle, so that the costs for a new unfiltered air connection can be saved.

It is particularly favourable that the unfiltered air connection has a guide rib, which prevents a direct approach flow of the filtering material. By the guide rib, an excessive loading of the filtering material at the unfiltered air opening is prevented, so that the filtering material is loaded uniformly with dirt, so that the lifespan of the filtering material as a whole is extended.

The guide rib can be constructed so as to be rigid. This is favourable for example when owing to the air flow high forces act on the guide rib. In addition, the guide rib can be constructed so as to be permeable to air and flexible; thereby, the guide rib can place itself for example against the filtering material and can protect the filtering material locally from too high a loading with dust or similar.

In addition it is favourable if the guide rib is held adjustably, by telescopic cylinders, on the unfiltered air connection. Thereby, uniform elements, therefore uniform guide ribs and unfiltered air connections can be used for different filter elements, in particular with a different distance between outer wall and filtering material. Thereby, the storage costs are reduced.

Alternatively or additionally hereto, provision can be made that the filter element has a guide rib which is arranged between the unfiltered air opening and the filtering material, and is held on at least one of the end plates. For example, the guide rib is held with at least one of the end plates by plasticizing. Compared to a mounting by telescopic cylinders, turbulences at the telescopic cylinders can be prevented.

Furthermore, it is advantageous if the guide rib has recesses through which the unfiltered air, coming from the unfiltered air inlet, can flow directly to the filtering material. Thereby, it can be prevented that the region of the filtering material directly behind the guide rib is flowed against too little.

An advantageous variant makes provision that a passage area of the at least one unfiltered air opening is smaller than a filter area of the filtering material. In this way, on the one hand, the filtering material is protected from mechanical influences from the exterior, so that damage can be prevented. On the other hand, through the fact that the filter area of the filtering material is greater than the passage area of the at least one unfiltered air opening, a small flow resistance is achieved through the filter element.

It is particularly advantageous that at least one unfiltered air opening extends in the outer wall and in one of the end plates. This means that the unfiltered air opening extends at an angle. Thereby, the filter element can be adapted in a particularly flexible manner.

A particularly favourable solution makes provision that the filter element has a front plate, on which at least one filtered air opening is formed. The front plate, together with the two end plates and the filtering material, closes the filtered air zone of the filter element, so that the filtered air opening, which is arranged in the front plate, enables direct access to the filtered air zone and therefore the filtered air can flow from the filtered air zone through the filtered air opening out from the filter element.

In addition, it is particularly favourable that the front plate is arranged transversely, in particular substantially perpendicularly, to the end plates. Thereby, a particularly compact construction of the filter element can be achieved.

In addition, a particularly advantageous solution makes provision that the filter element has at least one filtered air opening, which is arranged in one of the end plates. On the one hand, thereby the flexibility of the filter element can be further increased. On the other hand, a further filtered air opening, which is arranged in one of the end plates, can be provided. Therefore, for example, a further unit of a motor vehicle can be supplied with clean air.

It is favourable that the filter element has an intermediate wall, which runs between the outer wall and the filtering material in the unfiltered air zone and which has a plurality of recesses. Thereby, a region of the unfiltered air zone is separated by the intermediate wall, which lies between the intermediate wall and the outer wall. Through the recesses, however, a fluidic connection still exists between this region and the remaining unfiltered air zone. The region between the outer wall and the intermediate wall can thereby operate as a resonator and can thereby damp the noise development of the internal combustion engine.

Furthermore, it is favourable that the filter element has an intermediate wall, which runs between the outer wall and the filtering material in the filtered air zone and which has a plurality of recesses. Thereby, a region of the filtered air zone is separated by the intermediate wall, which lies between the intermediate wall and the outer wall. Through the recesses, however, a fluidic connection still exists between this region and the remaining filtered air zone. The region between the outer wall and the intermediate wall can thereby operate as a resonator and can thereby damp the noise development of the internal combustion engine.

It is favourable that a resonator is formed between the intermediate wall and the outer wall. In addition, it is favourable for the production of the filter element if the intermediate wall is formed from a functional strip. Moreover, a compact construction can be favourably achieved if the intermediate wall runs transversely, in particular substantially perpendicularly, to the end plates.

It is advantageous that the filter element has a pre-filter, which is arranged in the unfiltered air zone in front of the filtering material, which is constructed in a wall-shaped manner and has recesses covered with non-woven material. The non-woven material can have, for example, larger pores than the filtering material, so that the non-woven material of the pre-filter brings about a coarse pre-filtering, in particular of larger particles or drops of moisture, from the air which is to be filtered. Consequently, the filtering material is less intensively stressed. In an advantageous manner, the pre-filter is formed from a functional strip.

In the description and in the enclosed claims, wall-shaped is understood to mean that an extent in a first spatial direction is distinctly smaller than in the two remaining spatial directions. In particular, the extent in the two remaining spatial directions is at least five times, preferably at least ten times, particularly preferably at least twenty times as great as in the first spatial direction.

An advantageous variant makes provision that the filter element has an inner frame, which is arranged in the filtered air zone, supports the filter element, is constructed in a wall-shaped manner and has recesses. Thereby, the inner frame can support the filter element, in particular against the back pressure of the air which is to be filtered, which flows through the filter element. Here, it is favourable for the production of the filter element if the inner frame is formed from a functional strip.

In a favourable manner, the filtering material runs in a U-shape or C-shape and encloses the filtered air zone at least partially. In this way, material costs can be saved, because the filtering material already closes off a majority of the filtered air zone. Furthermore, in this way a particularly compact construction of the filter element becomes possible.

Alternatively or additionally hereto, provision can be made that the filtering material runs in a straight line. In this way, also a narrow and long filter element is achieved, whereby the variety of the possible forms of the filter element is increased. Consequently, a high degree of adaptability of the filter element can be achieved in a favourable manner.

Advantageously, the filtering material is folded. Folded filtering materials have a large filter area in relation to the volume, so that a good filtering performance can be achieved with a low flow resistance.

It is favourable that the filtering material of the filter element is constructed in two parts, that the two parts of the filtering material run adjacent to one another and enclose the filtered air zone between them, and that the unfiltered air zone is divided in two and an external part of the unfiltered air zone is associated with each part of the filtering material. Thereby, the filtered air zone of the filter element is delimited by at least two sides by the filtering material, so that in relation to the size of the filter element a large effective filter area can be achieved.

It is particularly favourable that the filtering material of the filter element is constructed in two parts, that the two parts of the filtering material run adjacent to one another and enclose the unfiltered air zone between them, and that the filtered air region is divided in two and an external part of the filtered air zone is associated with each part of the filtering material. Thereby, the unfiltered air zone of the filter element is delimited by at least two sides by the filtering material, so that in relation to the size of the filter element a large effective filter area can be achieved. In addition, the two parts of the filtering material can be different, so that two separate filtered air circuits with different purity are formed.

It is advantageous that the distance between the outer wall and the filtering material varies over the length of the filtering material. In this way, the flow can be adapted, so that less air turbulence occurs and unnecessary flows are prevented.

It is particularly advantageous that the distance between the outer wall and the filtering material reduces, starting from the unfiltered air opening. In this way, the speed of flow within the unfiltered air zone can be kept at least approximately constant. At least the reduction of the speed of flow is weaker than with a constant cross-section of the unfiltered air zone. With a constant cross-section of the unfiltered air zone, in the region of the unfiltered air opening, the speed of flow of the air which is to be filtered is greater, because in this region more air must flow through the unfiltered air zone than further away from the unfiltered air opening, because the air which has already flowed through the filter element no longer has to flow through the unfiltered air zone.

A fluidically particularly favourable solution makes provision that the filter element and/or the unfiltered air zone are constructed in a V-shape.

The above-mentioned problem is further solved by a filter element for a filtering system according to the preceding description. The advantages of the filtering system therefore also exist for the filter element, to the preceding description of which reference is made in this respect.

In addition, the above-mentioned problem is solved by a method for producing a filter element of a filtering system according to the preceding description, wherein the outer wall of the filter element is formed from a functional strip and wherein the functional strip is joined by plasticizing at least to the protruding end plate. Through the fact that the outer wall of the filter element is formed from a functional strip, the storage can be reduced. From the functional strip universally different outer walls can be produced for different filter elements, in particular with different sizes. Consequently, the storage can be reduced to a single or at least few different functional strips. The plasticizing of the functional strip to the end plates enables a fluid-tight connection between the functional strip, therefore the outer wall and the end plates.

A favourable possibility makes provision that the intermediate wall of the filter element is formed from a functional strip and/or that the pre-filter is formed from a functional strip and/or that the inner frame is formed from a functional strip. Therefore, the outer wall, the intermediate wall, the pre-filter and the inner frame can be formed from the same functional strip, because in particular the respective height corresponds to the distance of the end plates, which is identical for these parts. Thus, a plurality of elements of the filter element can be formed with one type of functional strip. Thereby, the storage costs can be further reduced.

Preferably, the intermediate wall and/or the inner frame and/or the pre-filter can be connected by plasticizing at least with the protruding end plate. The advantages of the plasticizing, such as for example fluid-tight stable connection, also have a positive effect on the connection of the intermediate wall and/or of the inner frame and/or of the pre-filter with the protruding end plate.

A particularly favourable variant makes provision that with the plasticizing of a first component with a second component, the first component is heated locally at a connection site at which the second component is to be connected to the first component, until it is plastic, and then the second component is pressed onto the connection site. Thereby, the second component penetrates at least partially into the first component, whereby at least a form-fitting connection results. Furthermore, the second component is likewise heated by the heated first component and becomes plastic in the marginal region, so that also a substance-bonded connection results between the first and the second component.

A further particularly advantageous solution for the joining makes provision that the functional strip is pointed at connecting edges before the plasticizing with the protruding end plate; in this way, the dipping into the other component can be improved, or the pointed edge can be heated particularly easily and can therefore enable a good substance-bonded connection.

In addition, it is favourable if the functional strip is structured by forming rollers; for example an undulation shape or wedge shape can be impressed on the functional strip. The undulations and/or wedges run in particular transversely to a rolling-out direction of the functional strip. Thereby, the undulations and/or wedges increase the rigidity of the functional strip and therefore of the outer wall.

It is particularly advantageous that recesses are introduced into the functional strip by means of a punching roller, in particular by means of a variable punching roller. Thereby, the functional strip can be adapted individually to the respective requirements, in particular to the requirement of the outer wall, of the intermediate wall, of the pre-filter or of the inner frame.

A further particularly favourable variant for storage makes provision that the width of the functional strip is shortened. Thereby wider functional strips can also be used for the production of the filter element. This means that filter elements with different heights can be produced from one type of functional strip, so that the variety of filter elements which are able to be produced is increased without, in so doing, the number of functional strips which are to be stored having to be increased.

In addition, a particularly advantageous variant makes provision that the non-woven material is applied by plasticizing onto the functional strip, in particular via the recesses of the functional strip, which forms the outer wall or the pre-filter of the filter element. Thereby, the non-woven material can be connected in a laminar manner with the functional strip, without additional materials such as adhesives having to be used. Therefore, a favourably-priced production of the outer wall and of the pre-filter arises.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained further in the following description, wherein the same reference numbers refer to identical or similar or functionally identical components.

### BRIEF DESCRIPTION OF THE DRAWINGS

There are shown, respectively diagrammatically:

FIG. 1 a perspective illustration of a filter element according to the invention,

FIG. 2 a sectional illustration along the section plane A of FIG. 1 of a second variant of the filter element,

FIG. 3 a sectional illustration along the plane B through the filter element of FIG. 1,

FIG. 4 a sectional illustration along the section plane A of FIG. 1 of the second variant of the filter element, wherein additional optional elements are illustrated,

FIG. 5 a schematic diagram of a filtering system comprising a holder and the filter element,

FIG. 6 a sectional illustration along the plane A of FIG. 1 of the first variant of the filter element,

FIG. 7 a sectional illustration along the plane A of FIG. 1 of a third variant of the filter element,

FIG. 8 a perspective illustration of an unfiltered air connection with a non-woven material,

FIG. 9 a perspective view of an unfiltered air connection with a guide rib,

FIG. 10 a sectional illustration along a horizontal plane through the unfiltered air connection of FIG. 9,

FIG. 11 a perspective view of an outer wall with an unfiltered air connection inserted in the outer wall,

FIG. 12 a top view onto the outer wall of FIG. 13, to illustrate the connection between the unfiltered air connection and the outer wall,

FIG. 13 a perspective sectional illustration along a section plane of a second embodiment of a filter element according to the invention, corresponding to plane A of FIG. 1,

FIG. 14 a schematic diagram of a cut-out of a sectional illustration along a section plane, corresponding to plane B of FIG. 1, through the filter element of FIG. 13,

FIG. 15 a-e perspective basic illustrations of a functional strip, from which an outer wall, an intermediate wall, a pre-filter or an inner frame is formed,

FIG. 16 a cross-sectional illustration through a functional strip,

FIG. 17 a schematic illustration of the introduction of recesses into the functional strip,

FIG. 18 a schematic illustration of the application of a non-woven material onto the functional strip,

FIG. 19 a sectional illustration along a section plane of a third embodiment of a filter element according to the invention, corresponding to plane A of FIG. 1,

FIG. 20 a perspective sectional illustration of the filter element of FIG. 19,

FIG. 21 a perspective sectional illustration along a section plane of a fourth embodiment of a filter element according to the invention, corresponding to plane A of FIG. 1,

FIG. 22 a perspective sectional illustration along a section plane of a fifth embodiment of a filter element according to the invention, corresponding to plane A of FIG. 1,

FIG. 23 a perspective sectional illustration along a section plane of a sixth embodiment of a filter element according to the invention, corresponding to plane A of FIG. 1,

FIG. 24 a sectional illustration along a section plane of a seventh embodiment of a filter element according to the invention, corresponding to plane B of FIG. 1, and

FIG. 25 an illustration corresponding to FIG. 14, wherein the filter element has a curved outer wall with a dust discharge valve.

### DETAILED DESCRIPTION

A filter element 10 illustrated in FIG. 1 is formed to be arranged for operation on a holder 44 of a filtering system 34. For this, the filter element 10 has a first end plate 12 and a second end plate 14, which are arranged substantially parallel to one another, a filtering material 16, which separates a filtered air zone 18 from an unfiltered air zone 20, and an outer wall 22, which at least partially surrounds the unfiltered air zone 20 and is held on the second end plate 14. In addition, the filter element 10 has a front plate 24, in which a filtered air opening 26 of the filter element 10 is arranged and which carries the filtered air connection 28. In addition, the filter element 10 has an unfiltered air opening 30, which is formed by an interruption 48 in the outer wall 22.

The outer wall 22 runs transversely, in particular perpendicularly, to the end plates 12, 14. The outer wall 22 can be formed as a separate component and can be connected with the second end plate 14. Alternatively, provision can be made that the outer wall 22 is formed integrally with the second end plate 14.

For the operation of the filtering system 34, the filter element 10 is placed against the holder 44 of the filtering system 34. The outer wall 22 then lies with a sealing element 23 against the holder 44, so that the holder 44 closes off here the unfiltered air zone 20. The holder 44 can be formed by a planar component. For example, the holder 44 can be formed by or on a bodywork part, a design cover, a housing cover, a cylinder head cover, an engine bonnet, an engine compartment rear wall or an oil sump.

In operation, unfiltered air is directed through the unfiltered air opening 30 into the filter element 10. Within the filter element 10, the unfiltered air must flow through the filtering material 16 and is thereby filtered. From the filtering material 16, filtered air enters accordingly into the filtered air zone 18 and can flow out through the filtered air opening 26 and, for example, can flow into a filtered air inlet of a filtering system 34, arranged at the filtered air connection 28.

The first end plate 12 and the second end plate 14 are constructed so as to be substantially flat and run substantially parallel to one another. The filtering material 16 is arranged between the two end plates and runs in a U-shape between the two end plates 12, 14. In this way, the filtering material 16 at least partially encloses the filtered air zone 18. At the open side of the U, the front plate 24 is arranged, which runs transversely, substantially perpendicularly, to the end plates 12 and 14 and connects the two end plates 12 and 14 with one another in this region, so that the filtered air zone is closed off by the front plate 24 in the region of the open U of the filtering material.

The front plate 24 has the filtered air opening 26, through which the air, filtered by the filtering material 16, can flow out from the filter element 10. In order to be able to direct the filtered air to the consumers, the front plate 24 has at the filtered air opening 26 a filtered air connection 28, to which the consumers can be connected directly or via a pipe.

Apart from in the front plate 24, the filter element 10 can have in addition further filtered air openings 26, for example in one of the end plates 12 or 14. The arrangement of the second filtered air opening 26 can take place alternatively or additionally, which means it is possible for example to have only one filtered air opening 26 either in one of the end plates 12, 14 or in the front plate 24, or both in the front plate 24 and also in one of the end plates 12 or 14 or even in both end plates 12 or 14. This can be expedient for example, if more than one consumer for filtered air is present. Otherwise, the flexible arrangement of the filtered air opening 26 offers great adaptation potential of the filter element 10 to given requirements.

Lying opposite the filtered air zone 18, in relation to the filtering material 16, the unfiltered air zone 20 is arranged, therefore outside the filtering material 16. The unfiltered air zone 20 is delimited by the second end plate 14, which protrudes beyond the filtering material 16, and delimits the holder 44. Toward the interior, the unfiltered air zone 20 is delimited by the filtering material 16 and toward the exterior the unfiltered air zone 20 is delimited by the outer wall 22. The outer wall 22 likewise runs substantially in a U-shape, therefore adapted to the course of the filtering material 16.

Here, the outer wall 22 has a distance from the filter material 16, in order to form the unfiltered air zone 20. In the region of the unfiltered air opening 30, the distance of the outer wall 22 to the filtering material 16 is greater than in regions which lie remote from the unfiltered air opening 30. As the unfiltered air zone 20 extends along the filtering material 16, through the unfiltered air zone 20 starting from the unfiltered air opening 30 at the beginning more unfiltered air must flow through the unfiltered air zone 20 than at the end of the unfiltered air zone 20. By the reducing distance between the outer wall 22 and the filtering material 16, the cross-section of the unfiltered air zone 20 also reduces according to the quantity of unfiltered air which flows through the unfiltered air zone 20, so that the flow resistance within the unfiltered air zone 20 varies less intensively than it would in the case of a constant cross-section of the unfiltered air zone 20.

In addition, in the unfiltered air zone 20 or filtered air zone 18 between the two end plates 12, 14 further elements can be arranged, for example a guide vane 36 by which the flow is influenced within the unfiltered air zone 20, in order to influence the loading of the filtering material 16 and/or to adjust this. Furthermore, one or more supporting domes 38 can be arranged between the end plates 12 and 14, in order to increase the stability of the filter element. Furthermore, it is possible to arrange one or more sensors 40, for example air mass or air quality sensors, in the filtered air zone 18 or unfiltered air zone 20. In addition, the possibility exists to provide for example a tension anchor 42, abbreviated to anchor 42, which draws the two end plates 12 and 14 to one another and therefore prevents oscillations of the two end plates 12 and 14. In addition, the anchor 42 can be used in order to hold the filter element 10 against the holder 44 of the filtering system 34.

Alternatively, the filter element 10 can also be held via the outer wall 22 on the holder 22. For example, detent lugs can be arranged on the outer wall 22, which engage in openings on the holder 44, or vice versa. In addition, the holder 44 can have grooves, into which the outer wall 22 can be inserted. Finally, a screwed connection or a clamping connection, for example with a bracket or a clamp, between the holder 44 and the outer wall 22 is also conceivable.

At the unfiltered air opening 30, the filter element 10 can have an unfiltered air connection 46, which is arranged for example in a recess, or interruption 48 of the outer wall 22. The unfiltered air connection 46 offers the possibility of the connection of further fluidic elements, for example of a pipe. The unfiltered air connection 46 has a cylindrical connection portion 50, to which for example a pipe can be connected. The connection portion 50 is arranged on a wall portion 51 which replaces the outer wall 22 within the interruption 48 of the outer wall 22.

In addition, at the unfiltered air connection 46 a guide rib 52 is arranged, which is arranged on a side of the wall portion 51 lying opposite the connection portion 50, and in the mounted state lies within the unfiltered air zone 20. To stabilize the filter element 10, provision can be additionally made that the guide rib 52 is connected to one or both end plates 12, 14. For example, the guide rib 52 can be connected to the end plates 12, 14 by plasticizing.

A connecting technique is designated as plasticizing in which one of the objects which is to be connected is heated at the connection site until the material becomes plastic, then the other object is pressed onto this connection site, so that the latter partially dips in and partially likewise becomes slightly plastic, so that a form-fitting and partially substance-bonded connection arises between the two objects.

Unfiltered air, which flows through the unfiltered air opening 30 in the unfiltered air connection 46 into the filter element 10, thereby impinges onto the guide rib 52, whereby the filtering material 16, which is arranged directly at the unfiltered air opening 30, can be protected from too intensive a loading.

The guide rib 52 can be held for example with telescopic cylinders 54 on the wall portion 51 of the unfiltered air connection 46. By the telescopic cylinders 54, the angle and the distance of the guide ribs 52 with respect to the filtering material 16 can be adapted, so that the unfiltered air connection 46 can be arranged in a variable manner at different locations in the outer wall 22 of the filter element 10. In particular, at locations with a different distance between outer wall 22 and filtering material 16. The telescopic cylinder can have fine ribs, which regulate a withdrawal force of the telescopic cylinders 54.

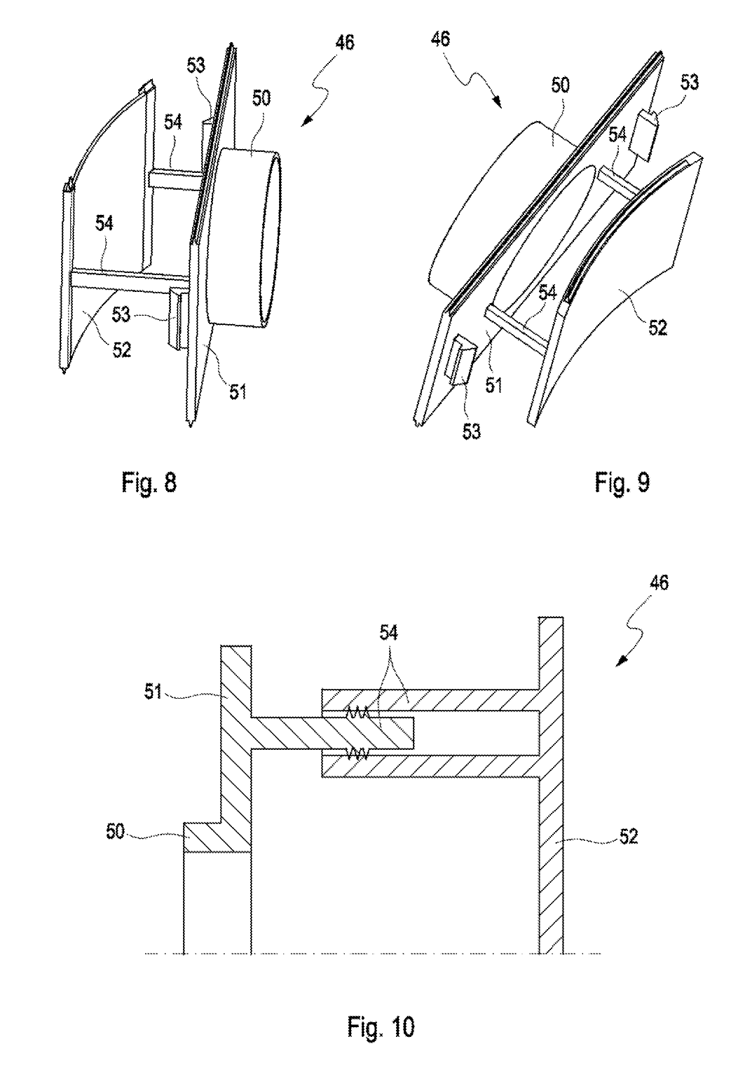

The connection from the unfiltered air connection 46, in particular of the wall portion 51 with the outer wall 22 is, for example a detent connection. Thus, for example, the unfiltered air connection 46 illustrated in FIGS. 8 and 9 has two detent lugs 53, which engage behind the outer wall 22, when the unfiltered air connection 46 is pushed from the exterior into the interruption 48 of the outer wall 22.

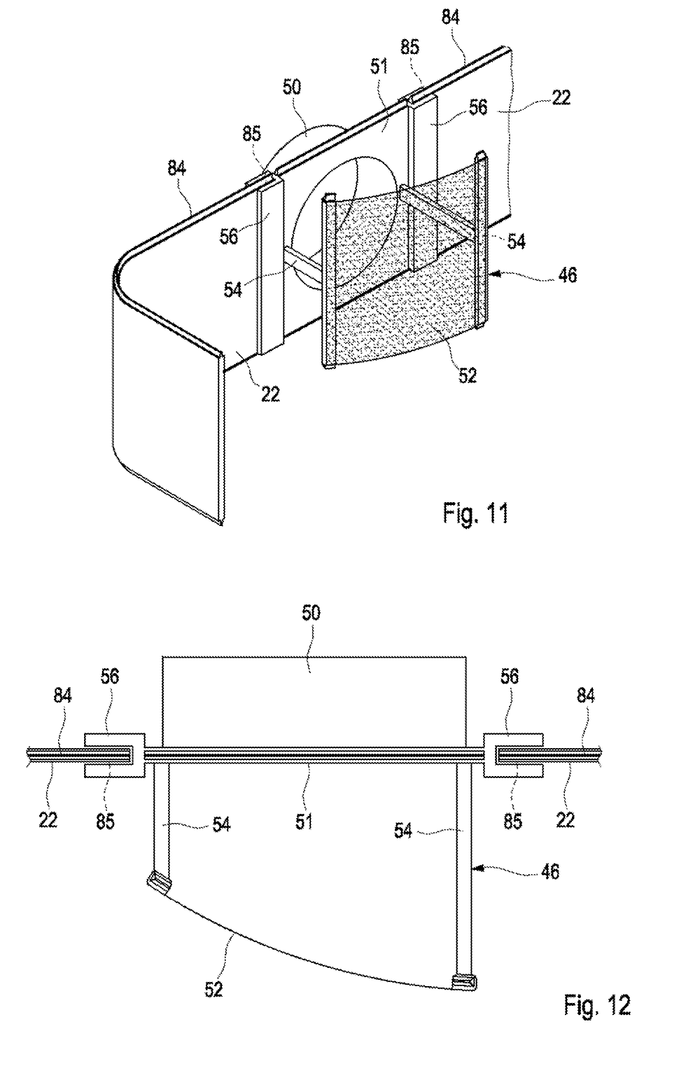

Alternatively hereto, for example as illustrated in FIGS. 11 and 12, the unfiltered air connection 46 can have connection elements 56 formed in a C-shape, which have a corrugation 85 on the inner side. Accordingly, the outer wall 22 is likewise corrugated. The corrugations 85 of the connection element 56 and of the outer wall 22 are oblique, so that the outer wall 22 can in fact push itself into the connection element 56, but a withdrawal of the outer wall 22 out from the connection element 56 is not possible, or is only possible with difficulty.

The guide rib 52 can be formed so as to be rigid or can be formed as a non-woven material, wherein then the guide rib 52 can lay itself against the filtering material 16.

In an alternative which is not shown, the unfiltered air connection 46 can also be held detachably on the outer wall 22 of the filter element 10. For example, the unfiltered air connection 46 can be held detachably by a screwed connection, a plug-in connection, clamping connection, a bracket or a clip connection on the filter element 10, in particular on the outer wall 22. In this alternative, provision can also be made that the guide rib 52 is held on at least one of the end plates 12, 14, instead of at the unfiltered air connection 46.

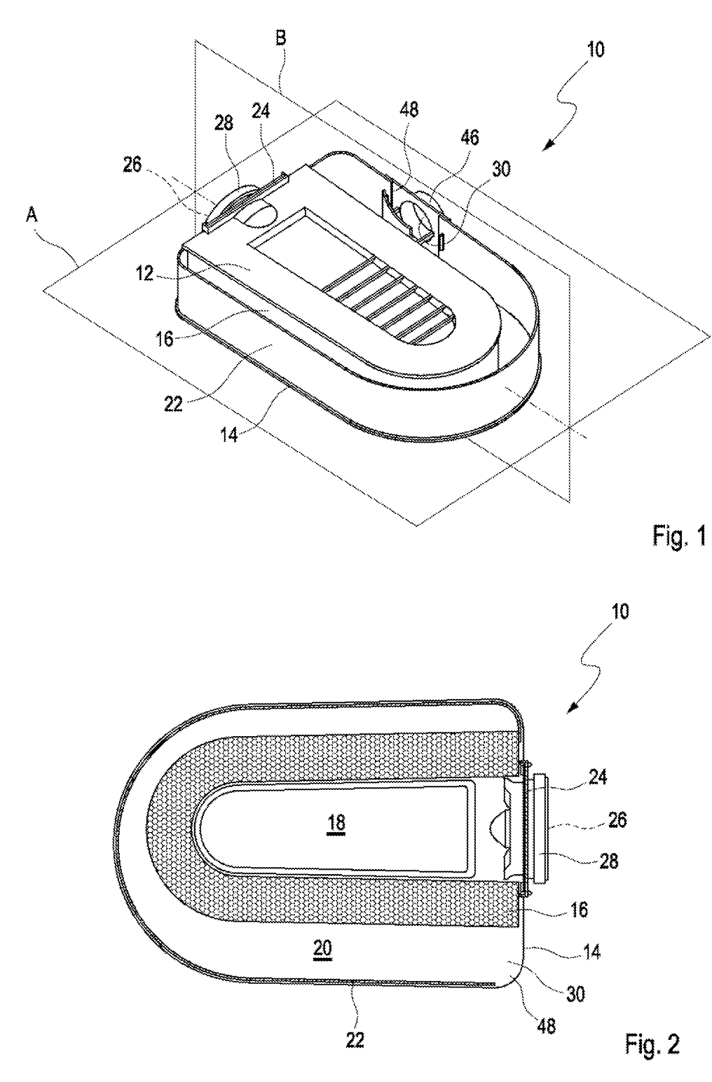

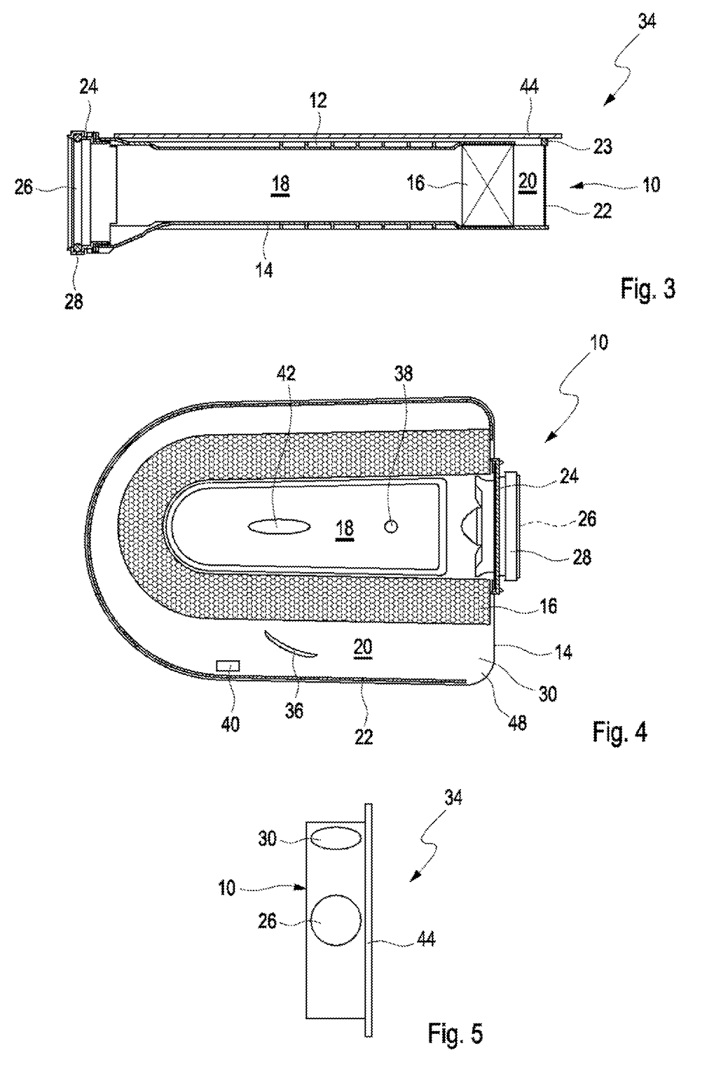

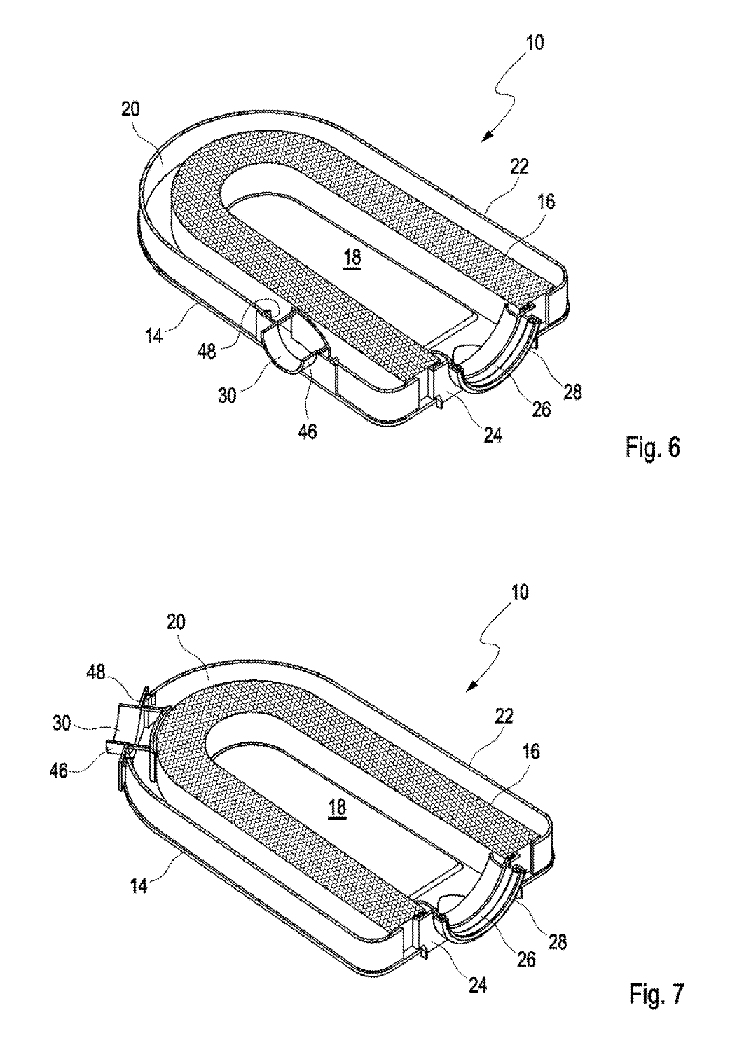

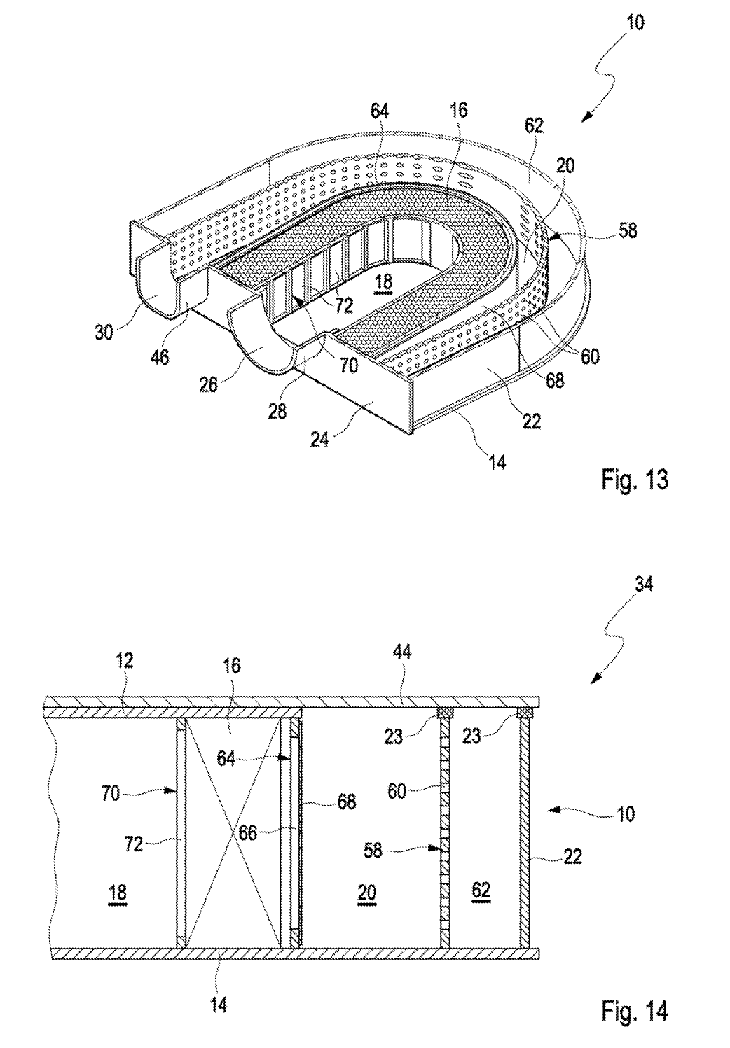

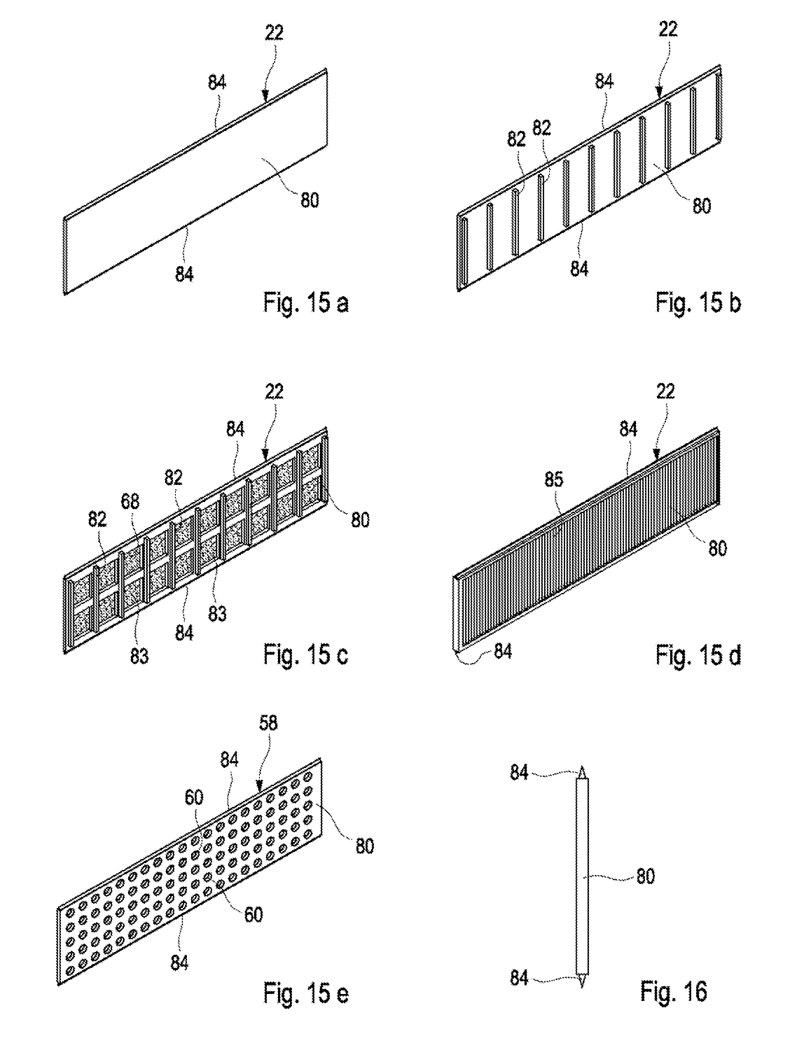

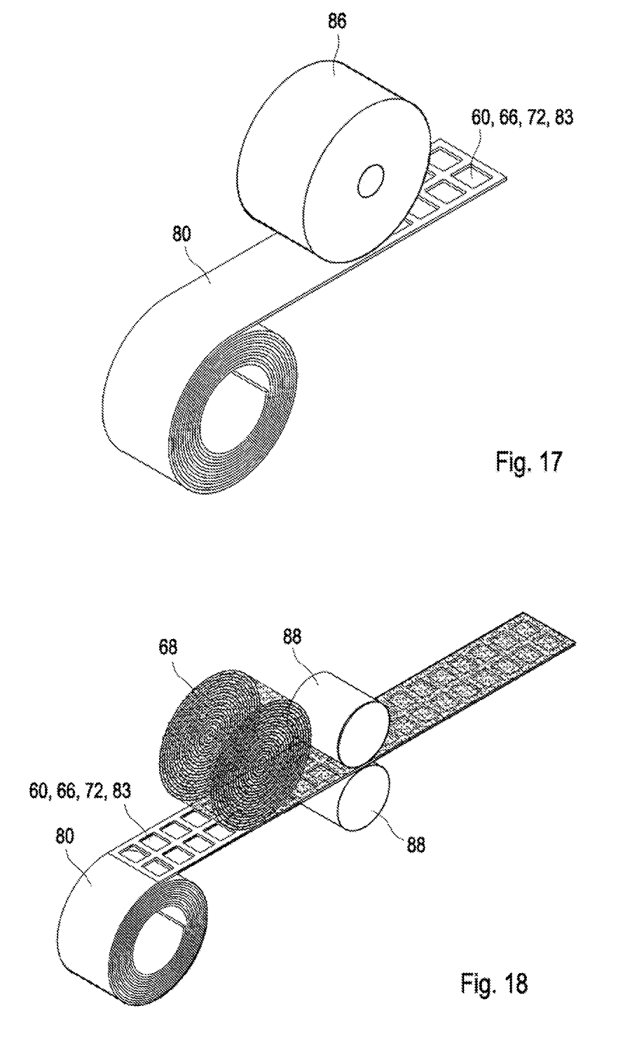

A second embodiment of the filtering system 34, illustrated in FIGS. 13 to 18, differs from the first embodiment of the filtering system 34 illustrated in FIGS. 1 to 12 in that the filter element 10 has further elements for improving or expanding the function of the filter element 10, as illustrated for example in FIG. 14.

Thus, for example, the filter element 10 can have an intermediate wall 58, which extends from the second end plate 14 to the holder 44 within the unfiltered air zone 20 and thereby subdivides the unfiltered air zone 20. On the intermediate wall 58 a sealing element 23 is arranged, which lies against the holder 44 when the filter element 10 is arranged on the holder 44.

The intermediate wall 58 has recesses 60, by which a connection is made possible between the two parts of the unfiltered air zone 20. Between the intermediate wall 58 and the outer wall 22, a resonator 62 is thereby formed, which can interact with the inner part of the unfiltered air zone 20 and can thereby reduce the noise development.

Furthermore, a pre-filter 64 can be arranged in front of the filtering material 16, which pre-filter has a plurality of recesses 66, which in turn are covered by an air-permeable medium, for example a non-woven material 68. The non-woven material 68 has coarser and/or larger pores here than the filtering material 16, so that the non-woven material 68 of the pre-filter removes coarser particles/dirt particles from the unfiltered air, before it flows through the filtering material 16. Thereby, the lifespan of the filter element 10 can be increased. Furthermore, the non-woven material 68 holds back drops of moisture.

In order to improve the stability of the filtering material 16, an inner frame 70 can be provided, which lies against the filtering material 16 on the side of the filtering material 16 facing the filtered air zone 18, in order to support the filtering material 16. For this, the inner frame 70 runs from the first end plate 12 up to the second end plate 14 and is connected to these two end plates 12, 14, so that the inner frame 70 can support the filtering material 16. So as not to impair the operation of the filter element 10, the inner frame 70 has recesses 72, through which the filtered air can flow through the inner frame 70 into the filtered air zone 18.

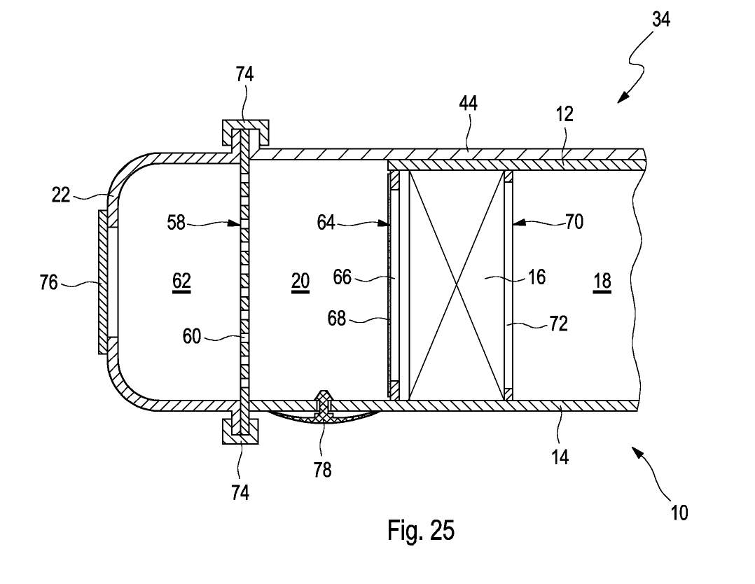

In a variant illustrated in FIG. 25, the outer wall 22 does not have a straight course between the second end plate 14 and the holder 44, but rather is curved outwards. The connection between the outer wall 22 and the second end plate 14 or respectively the holder 44, and to the intermediate wall 58 takes place here via clips 74, which hold together a flange-like projection of the outer wall 22 or of the holder 44 and the intermediate wall 58.

In the outer wall 22, a dust discharge valve 76 can be provided, by which dust, which was collected for example by the pre-filter 64 and has detached itself from the pre-filter 64, can be removed from the filter element 10. Furthermore, for example in the second end plate 14 a plug 78 can be provided, by which likewise dust or else water can be discharged from the filter element 10. The plug 78 is preferably constructed as a lip valve, which has lips which lie from the exterior on the filter element 10, so that the lip valve can open in the case of an excess pressure in the filter element 10. For example, the plug 78 opens in the case of a pressure pulsation at the pressure peaks, so that thereby dust and water can be automatically discharged from the filter element 10.

The outer wall 22, the intermediate wall 58, the pre-filter 64 and the inner frame 70 are preferably formed from a functional strip 80. The functional strip 80 is a plastic strip which is formed as an endless strip. Endless in this case means only very long, in particular the functional strip 80 is stored on rolls. The functional strip 80 therefore has a constant wall thickness and a constant width. Thereby, it is suitable both for the outer wall 22, for the intermediate wall 58, for the pre-filter 64 and the inner frame 70, because these elements have approximately the same height, because they run respectively from the first end plate 12 up to the second end plate 14, which run substantially parallel to one another.

The functional strip 80 can be modified respectively for the formation of the individual elements. For example, the functional strip 80 can be provided with reinforcement ribs 82, which for example give the outer wall 22 a greater stability and therefore give the filter element 10 a greater stability.

Alternatively or additionally hereto, provision can be made to impress an undulation and/or wedge shape on the functional strip 80. Thereby, also, the stability of the outer wall 22, formed from the functional strip 80, can be increased.

Furthermore, recesses 60, 66, 72, 83 can be introduced into the functional strip 80, in order to expand or enable the function of the individual elements. Thus, for example recesses 83 can be introduced in the outer wall 22, which in turn are covered by a non-woven material, so that condensation can flow out from the filter element through these recesses 83 in the outer wall 22. Furthermore, non-woven material can be applied onto the functional strip, in order for example to cover the recesses 66 of the pre-filter. This can take place for example by plasticizing or gluing.

Finally, the functional strip 80 can be provided with a corrugation 85, which increases both the rigidity of the functional strip and also enables a detent connection, for example to the unfiltered air connection 46.

The elements which are formed from the functional strip 80, therefore the outer wall 22, the intermediate wall 58, the filter 64 and the inner frame 70 are connected for example by plasticizing at least to the second end plate 14. In order to simplify or improve the plasticizing, the functional strip 80 can be pointed at a connection edge 84, by which the elements, which are formed from the functional strip 80, are arranged on the end plates 12, 14 (see FIG. 16).

The recesses 60, 66, 72, 83 can be introduced into the functional strip 80 by a punching roller 86, preferably by a variable punching roller 86. The non-woven material 68 can be pressed onto the functional strip 80 for example by a pressing roller 88. After the functional strip 80 has been heated, the functional strip 80 is plastic at least on the surface, so that the non-woven material 68 connects with the functional strip 80.

Otherwise, the second embodiment of the filtering system 34 illustrated in FIGS. 13 to 18 coincides with regard to structure and function with the first embodiment of the filtering system 34 illustrated in FIGS. 1 to 12, to the above description of which reference is to be made in this respect.

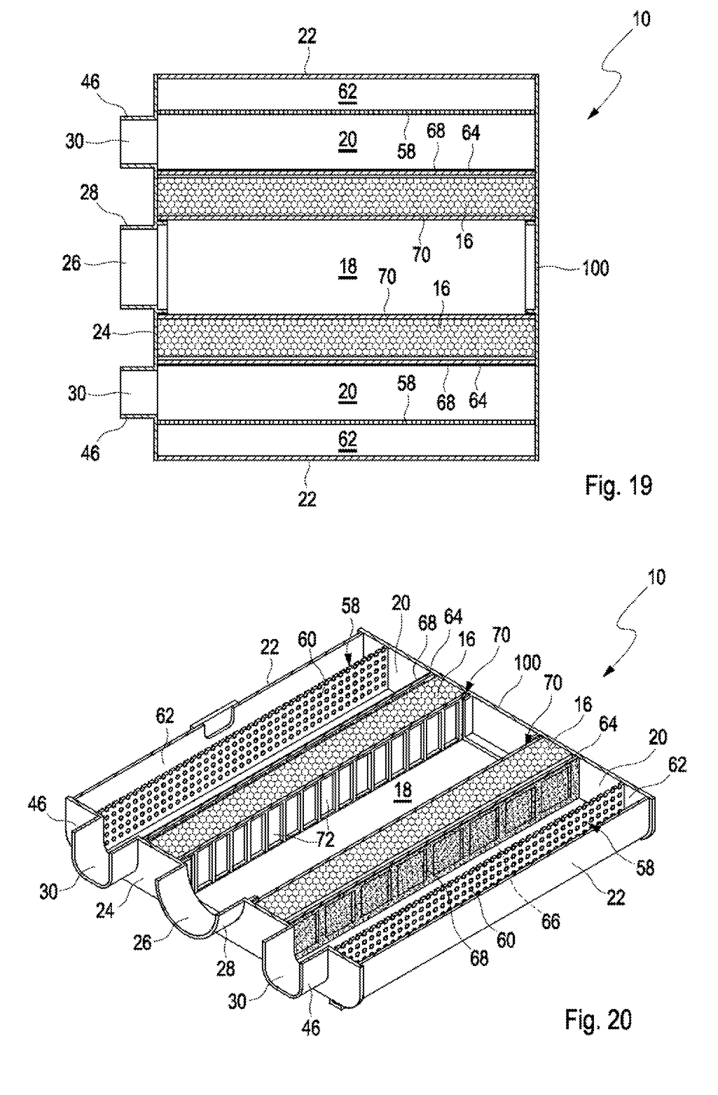

A third embodiment of the filtering system 34 illustrated in FIGS. 19 and 20 differs from the second embodiment of the filtering system 34 illustrated in FIGS. 13 to 18 in that the filtering material 16 is divided in two and runs in a straight line, wherein the filtered air zone 18 lies between the two parts of the filtering material 16, the two end plates 12, 14 of the front plate 24 and a back plate 100, which runs transversely to the two end plates 12, 14 and connects the first end plate 12 with the second end plate 14.

Thereby, the filter element 10 has two unfiltered air zones 20, separated from one another, which are arranged externally on both sides of the filtering material 16. The front plate 24 has, furthermore, the filtered air opening 26, through which filtered air from the filtered air zone 18 can flow out from the filter element 10. Furthermore, the front plate 24 has two unfiltered air openings 30, which belong respectively to one of the two unfiltered air zones 20 and through which unfiltered air can flow into the filter element 10.

It shall be understood that the unfiltered air openings 30 can also be arranged in the back plate 100, in the outer walls 22, and/or at an angle in the outer wall 22 and the end plates 12, 14. In addition, it shall be understood that the arrangement of the filtered air opening 26 is not restricted to the front plate 24.

Alternatively hereto, provision can also be made that unfiltered air zone 20 and filtered air zone 18 are exchanged. The filter element 10 would then have two filtered air zones 18, separately from one another, which can also have a different quality, if the two parts of the filtering material 16 are selected accordingly.

Otherwise, the third embodiment of the filtering system 34 illustrated in FIGS. 19 and 20 coincides with the second embodiment of the filtering system 34 illustrated in FIGS. 13 to 18 as regards structure and function, the above description of which is to be referred to in this respect.

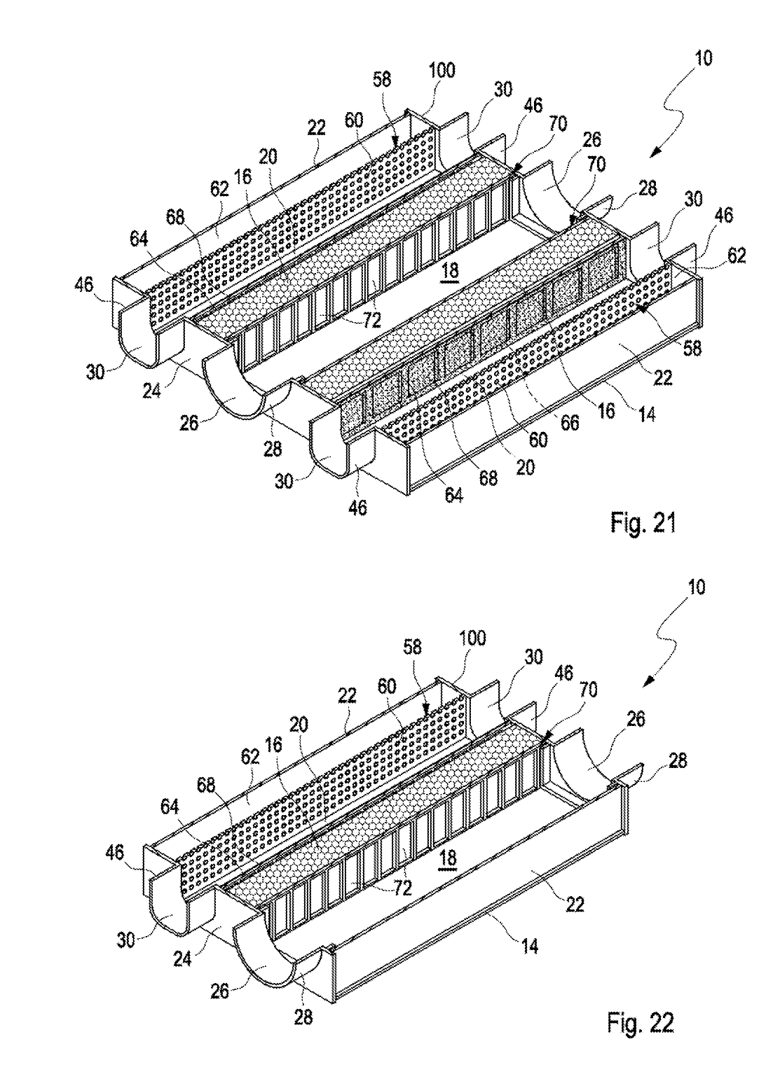

A fourth embodiment of the filtering system 34 illustrated in FIG. 21 differs from the third embodiment of the filtering system 34 illustrated in FIGS. 19 and 20 in that the back plate 100 also has a filtered air opening 26, a filtered air connection 28 and two unfiltered air openings 30 with associated unfiltered air connections 46.

Otherwise, the fourth embodiment of the filtering system 34 illustrated in FIG. 21 coincides with the third embodiment of the filtering system 34 illustrated in FIGS. 19 and 20 as regards structure and function, the above description of which is to be referred to in this respect.

A fifth embodiment of the filtering system 34 illustrated in FIG. 22 differs from the fourth embodiment of the filtering system 34 illustrated in FIG. 21 in that the filter element 10 has only one unfiltered air zone 20 and one filtering material 16.

Alternatively or additionally hereto, provision can be made that in the filtered air zone 18 an intermediate wall can be arranged, which forms a resonator 62 between the intermediate wall and the outer wall 22.

Otherwise, the fifth embodiment of the filtering system 34 illustrated in FIG. 22 coincides with the fourth embodiment of the filtering system 34 illustrated in FIG. 21 with regard to structure and function, to the above description of which reference is to be made in this respect.

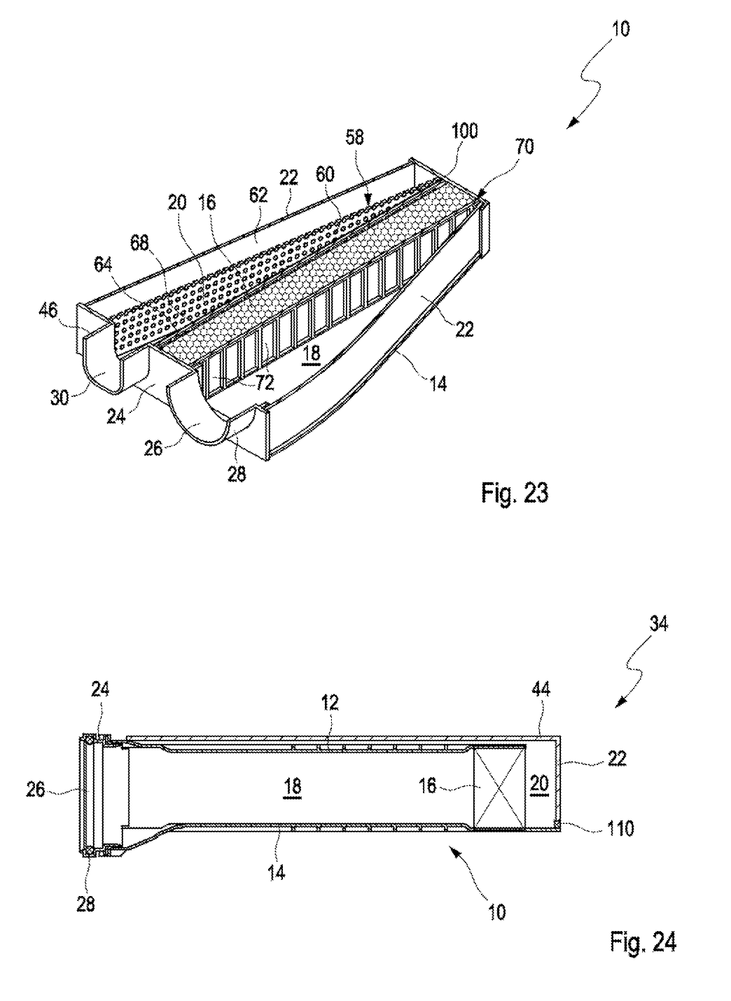

A sixth embodiment of the filtering system 34 illustrated in FIG. 23 differs from the fifth embodiment of the filtering system 34 illustrated in FIG. 22 in that a filtered air opening 26 and an unfiltered air opening 30 are arranged only in the front plate 24, and in that the unfiltered air zone 20 and the filtered air zone 18 taper in a wedge-shaped manner.

This is achieved in that the outer wall 22 at the unfiltered air zone 20 starting from the unfiltered air opening 30 up to the back plate 100 reduces the distance to the filtering material 16, and that the intermediate wall 58 likewise runs such that a distance from the intermediate wall 58 to the filtering material 16 reduces, starting from the unfiltered air opening 30 up to the back plate 100.

1. A filtering system for a motor vehicle, comprising:
a holder and an exchangeable filter element, the filter element including a first end plate, a second end plate and a filtering material arranged between the first end plate and the second end plate that separates a filtered zone from an unfiltered zone;
at least one filtered opening and at least one unfiltered opening, the at least one filtered opening disposed in the filter element, wherein the filter element lies detachably on the holder;
at least the second end plate protrudes beyond the filtering material;
the holder, the second end plate, the filtering material and an outer wall enclose the unfiltered zone;
the unfiltered zone defined between the filtering material and the outer wall;
the outer wall runs along a course of the filtering material;
the outer wall runs transversely to the first end plate and the second end plate; and
wherein one of:
the outer wall is disposed securely on the second end plate, and the outer wall lies loosely on the holder; and
the outer wall is disposed securely on the holder, and the outer wall lies loosely on the second end plate.

2. The filtering system according to claim 1, wherein the unfiltered zone has channel-shaped structure.

3. The filtering system according to claim 1, wherein the outer wall includes one or more recesses covered by a non-woven material.

4. The filtering system according to claim 1, wherein the outer wall has at least one interruption providing a receiving area and at least one receiving element is arranged in the at least one interruption.

5. The filtering system according to claim 1, wherein at least one of:
the filter element further includes a front plate and the at least one filtered opening is disposed in the front plate; and
the filter element has at least one further filtered opening disposed in the second end plate.

6. The filtering system according to claim 1, wherein at least one of:
the filtering element further includes an intermediate wall, the intermediate wall extending between the outer wall and the filtering material in at least one of the unfiltered zone and the filtered zone, wherein the intermediate wall has a plurality of recesses;
the filtering element further includes a pre-filter arranged in the unfiltered zone in front of the filtering material with respect to a flow direction, the pre-filter having a wall-shaped structure and one or more recesses covered with a non-woven material; and
the filter element further includes an inner frame arranged in the filtered zone that supports the filtering material, the inner frame having a wall-shaped structure and one or more further recesses.

7. The filtering system according claim 1, wherein one of:
the filtering material runs in a curved shape and at least partially encloses the filtered zone; and
the filtering material runs in a straight line.

8. The filtering system according to claim 1, wherein:
the filtering material of the filter element includes two parts;
the two parts of the filtering material run adjacent to one another and enclose the filtered zone therebetween; and
the unfiltered zone is divided in two and an external part of the unfiltered zone is associated with each of the two parts of the filtering material.

9. A method for the production of a filter element of a filtering system, comprising:
providing a first end plate, a second end plate, and a filtering material arranged between the first end plate and the second end plate to separate a filtered zone from an unfiltered zone, wherein at least the second end plate protrudes beyond the filtering material;
providing an outer wall extending along the filtering material between the first end plate and the second end plate, the outer wall extending transversely to the first end plate and the second end plate, wherein the unfiltered zone is defined between the filtering material and the outer wall, and wherein the outer wall is secured to one of the second end plate and a holder, and the outer wall lies loosely against the other of the second end plate and the holder;
wherein providing the outer wall includes forming the outer wall from a functional strip; and
joining the functional strip by plasticizing at least to the second end plate.

10. The method according to claim 9, further comprising at least one of:
forming an intermediate wall from a further functional strip, the intermediate wall disposed between the outer wall and the filtering material;
forming a pre-filter from a further functional strip, the pre-filter disposed in the unfiltered zone upstream of the filtering material; and
forming an inner frame that supports the filtering material from a functional strip.

11. The method according to claim 9, wherein joining the joining the functional strip by plasticizing includes locally heating a first component at a connection site where a second component is to be connected to the first component until the first component is plastic, and then pressing the second component is onto the connection site the first component, and wherein the functional strip is one of the first component and the second component, and the second end plate is the other of the first component and the second component.

12. The method according to claim 9, further comprising at least one of:
forming the functional strip with a pointed connection edges before the plasticizing with the second end plate;
punching one or more recesses into the functional strip via a punching roller; and
shortening a width of the functional strip.

13. The method according to claim 9, further comprising applying a non-woven material onto the functional strip by plasticizing.

14. The method according to claim 9, further comprising structuring the functional strip forming rollers.

15. The method according to claim 14, wherein structuring the functional strip includes impressing at least one of an undulation shape and a wedge shape on the function strip.

16. The filtering system according to claim 1, wherein the filter element is an air filter element for filtering air.

17. The filtering system according to claim 16, wherein the filter element further includes an intermediate wall extending between the outer wall and the filtering material in at least one of the unfiltered zone and the filtered zone, wherein the intermediate wall has a plurality of recesses.

18. The filtering system according to claim 16, wherein the filter element further includes a pre-filter arranged in the unfiltered zone upstream of the filtering material, the pre-filter having a wall-shaped structure and a plurality of recesses covered with a non-woven fabric.

19. The filtering system according to claim 16, wherein the filter element further includes an inner frame that supports the filtering material arranged in the filtered zone, the inner frame having a wall-shaped structure and a plurality of recesses.

20. The filtering system according to claim 2, wherein the channel-shaped structure has a rectangular cross-section and a curved shape.
